(19) United States
(12) Patent Application Publication
(10) Pub. No.: US 2026/0221891 A1
(43) Pub. Date: Jul. 30, 2026

(54) INTEGRATED ARCHITECTURE OF POWER TRANSFORMATION SYSTEM

(71) Applicant: Sungrow Power Supply Co., Ltd., Hefei, Anhui (CN)

(72) Inventors: Fei Wu, Hefei (CN); Hao Zheng, Hefei (CN); Xiaohu Wang, Hefei (CN)

(73) Assignee: Sungrow Power Supply Co., Ltd., Hefei, Anhui (CN)

(21) Appl. No.: 19/148,252

(22) PCT Filed: Sep. 6, 2023
(86) PCT No.: PCT/CN2023/117219

§ 371 Date: Jul. 15, 2025

(30) Foreign Application Priority Data
Jan. 16, 2023 (CN) 202320158845.8

(51) Int. Cl. H02M 7/00; H02B 1/21; H02B 1/34; H02B 1/56

(52) U.S. Cl. CPC H02M 7/003; H02B 1/21; H02B 1/34; H02B 1/565

(57) ABSTRACT

An integrated architecture of a power transformation system includes a first loading platform and a second loading platform, which are arranged in sequence in an X direction. The first loading platform is loaded with a voltage boosting and power distribution control device. The second loading platform includes a second loading area, the second loading area includes at least one loading rack, which is arranged in sequence in the X direction and/or a Y direction, each loading rack includes multiple loading layers arranged in sequence in a Z direction, and the loading layers are used for loading power transformation modules.

This application is a national stage filing under 35 U.S.C. § 371 of International Patent Application Serial No. PCT/CN2023/117219, filed Sep. 6, 2023, which claims the priority to Chinese Patent Application No. 202320158845.8, titled “INTEGRATED ARCHITECTURE OF POWER TRANSFORMATION SYSTEM”, filed on Jan. 16, 2023 with the China National Intellectual Property Administration. The contents of these applications are incorporated herein by reference in their entirety.

### FIELD

The present application relates to the technical field of power conversion equipment, and in particular to an integrated architecture of a power conversion system.

### BACKGROUND

In related art, multiple power conversion modules in a power conversion system are generally arranged on a single flat plate in an attempt to combine the advantages of both centralized and string-based solutions. However, in most of the cases, the power conversion modules are simply arranged on a platform with expanded area to accommodate more power conversion modules, while the power conversion modules, fuses and switches for various input and output paths, transformers and the like remain scattered in the layout.

### SUMMARY

In view of this, an integrated architecture of a power conversion system is provided according to the present application.

The following technical solutions are provided according to the present application.

An integrated architecture of a power conversion system includes a first loading platform and a second loading platform arranged sequentially along an X direction.

The first loading platform is equipped with a voltage boosting and power distribution control device.

The second loading platform includes a second loading zone, which is provided with at least one loading rack, the loading rack includes multiple loading layers arranged sequentially in a Z direction, and the multiple loading layers are configured to accommodate power conversion modules.

When there is one loading rack, the one loading rack is arranged in the X direction or a Y direction; and when there are multiple loading racks, the multiple loading racks are arranged sequentially in the X direction and/or the Y direction.

The X direction is a length direction of the integrated architecture, the Y direction is a width direction of the integrated architecture, and the Z direction is a height direction of the integrated architecture.

### BRIEF DESCRIPTION OF THE DRAWINGS

For more clearly illustrating embodiments of the present application or technical solutions in the related art, the drawings referred to for describing the embodiments or the related art will be briefly described hereinafter. Apparently, the drawings in the following description are only some examples of the present application, and for those skilled in the art, other drawings may be obtained based on the provided drawing without any creative efforts.

FIG. 1 is a schematic front view showing the structure of an integrated architecture of a power conversion system according to an embodiment of the present application;

FIG. 2 is a schematic side view showing the structure of the integrated architecture of the power conversion system according to the embodiment of the present application;

FIG. 3 is a schematic perspective view showing the structure of the integrated architecture of the power conversion system according to the embodiment of the present application (with protective door panels mounted on a switch control module);

FIG. 4 is a schematic perspective view showing the structure of the integrated architecture of the power conversion system according to the embodiment of the present application (where an integrated switch control unit of the switch control module integrates a DC switch assembly and an AC switch assembly);

FIG. 5 is a schematic side view of the structure where a cooling air duct is formed between two loading racks according to an embodiment of the present application;

FIG. 6 is a schematic top view of the structure where the cooling air duct is formed between the two loading racks according to the embodiment of the present application;

FIG. 7 is a schematic view showing an air inlet and an air outlet of a power conversion module according to an embodiment of the present application being provided along an X direction;

FIG. 8 is a schematic view showing an integrated DC switch module being arranged at an end side of a first loading platform and an integrated AC switch module being arranged below a loading rack according to an embodiment of the present application;

FIG. 9 is a schematic view showing a first loading platform and a second loading platform being in an integral structure according to an embodiment of the present application;

FIG. 10 is a schematic view showing a first loading platform and a second loading platform being separate structures fixedly connected to each other according to an embodiment of the present application;

FIG. 11 is a schematic view showing an embodiment of the present application where an integrated DC switch module is mounted below one loading rack;

FIG. 12 is a schematic view showing the embodiment of the present application where an integrated AC switch module is mounted below another loading rack;

FIG. 13 is a schematic view showing the embodiment of the present application where an integrated DC switch module and an integrated AC switch module are mounted below another two loading racks, respectively.

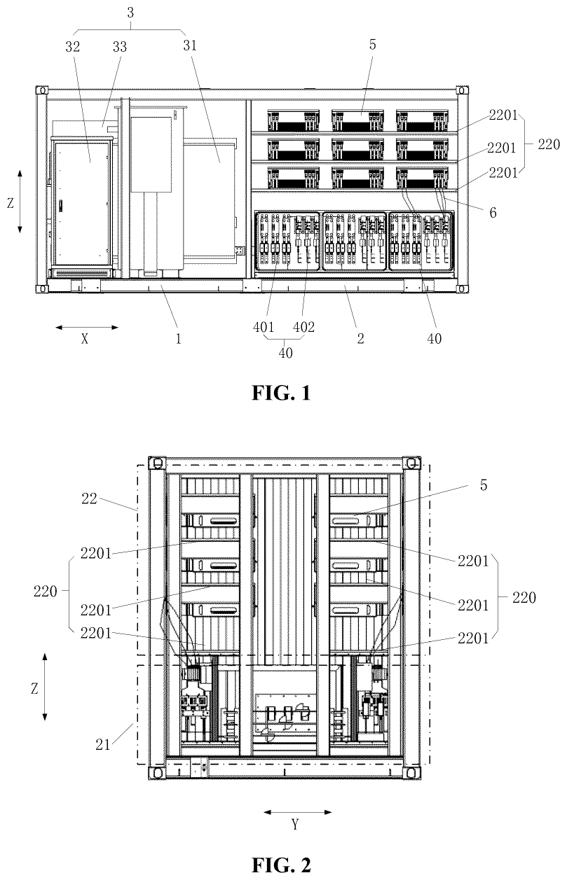

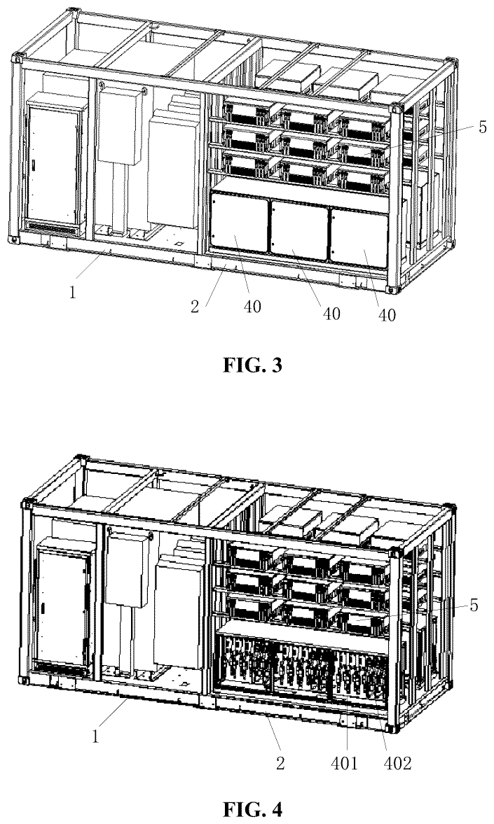

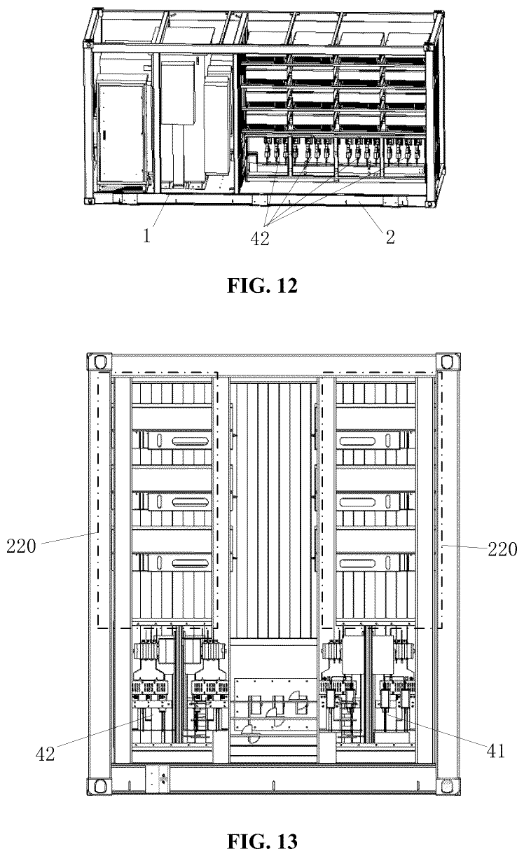

Reference numerals in FIG. 1 to FIG. 13 are listed as follows:

| | | | |
|---|---|---|---|
| 1 | first loading platform, | 2 | second loading platform, |
| 21 | first loading zone, | 22 | second loading zone, |
| 220 | loading rack, | 2201 | loading layer, |
| 221 | cooling air duct, | 222 | fan, |
| 3 | voltage boosting and power | | |
| | distribution control device, | | |
| 31 | medium-voltage transformer, | 32 | distribution cabinet, |
| 33 | communication cabinet, | 4 | switch control module, |
| 40 | integrated switch control unit, | 401 | DC switch assembly, |
| 402 | AC switch assembly, | 41 | integrated DC switch |
| | | | module, |
| 42 | integrated AC switch module, | 5 | power conversion module, |
| 6 | connecting cable. | | |

### DETAILED DESCRIPTION OF THE EMBODIMENTS

An integrated architecture of a power conversion system is provided according to the present application, to address the issues of low space utilization and poor product cost-effectiveness in the power conversion system.

The technical solutions according to the embodiments of the present application will be described clearly and completely as follows in conjunction with the drawings in the embodiments of the present application. It is apparent that the described embodiments are only some of the embodiments according to the present application, rather than all the embodiments. Any other embodiments obtained by those skilled in the art based on the embodiments of the present application without any creative work fall within the protection scope of the present application.

With reference to FIGS. 1 to 4, an integrated architecture of a power conversion system is provided according to the present application, including a first loading platform 1 and a second loading platform 2 which are arranged in sequence in an X direction. The first loading platform 1 is equipped with a voltage boosting and power distribution control device 3. The second loading platform 2 includes a second loading zone 22, which includes at least one loading rack 220. Each loading rack 220 includes multiple loading layers 2201 arranged in sequence in a Z direction, where the loading layers 2201 are used for accommodating power conversion modules 5 (for example, accommodating multiple power conversion modules 5 arranged sequentially in the X direction). The loading racks 220 are arranged sequentially in the X direction and/or the Y direction. When there is one loading rack 220, the loading rack 220 is arranged along the X direction or the Y direction. When there are multiple loading racks 220, they are arranged sequentially in the X direction and/or the Y direction. For example, all of the loading racks 220 are arranged sequentially in the X direction, or all of the loading racks 220 are arranged sequentially in the Y direction, or some of the loading racks 220 are arranged sequentially in the X direction while others are arranged sequentially in the Y direction. The X direction is a length direction of the integrated architecture, the Y direction is a width direction of the integrated architecture, and the Z direction is a height direction of the integrated architecture.

In practical application of the integrated architecture, the voltage boosting and power distribution control device 3 is loaded onto the first loading platform 1. The second loading platform 2 includes a second loading zone 22, which includes at least one loading rack 220. Each loading rack 220 includes multiple loading layers 2201 arranged sequentially in the Z direction, where the loading layers 2201 are used for accommodating power conversion modules 5, for example, accommodating multiple power conversion modules 5 arranged sequentially in the X direction. In this way, the power conversion modules 5 can be arranged in the second loading zone 22 in all the X, Y, and Z directions, thereby enabling more power conversion modules 5 to be loaded in a limited space, resulting in a more compact structural layout, significantly increasing the power density per unit space, and greatly enhancing the space utilization of the power conversion system, as well as improving the economic performance of the product.

It should be noted that the above power conversion modules 5 may specifically be energy storage converters, photovoltaic inverters, or other power conversion modules known to those skilled in the art, which will not be specifically limited herein. In addition, as shown in FIG. 1, the above voltage boosting and power distribution control device 3 may specifically include a medium-voltage transformer 31, a distribution cabinet 32, and a communication cabinet 33. The installation positions of the medium-voltage transformer 31, the distribution cabinet 32, and the communication cabinet 33 on the first loading platform 1 are not limited, and can be determined based on actual needs during practical application.

In some specific implementations, the numbers of power conversion modules 5 accommodated on two loading layers 2201 of a same loading rack may be the same or different, which can be determined based on actual needs of practical application.

In some other specific implementations, when the second loading zone 22 includes multiple (here referring to two or more) loading racks 220, the numbers of loading layers 2201 in different loading racks may be the same or different.

In further implementations, when the second loading zone 22 includes multiple (here referring to two or more) loading racks 220 and the numbers of loading layers 2201 in different loading racks are the same, the multiple loading racks 220 are arranged sequentially in the Y direction (i.e., the width direction of the integrated architecture), and two loading layers 2201 sharing the same ordinal position in their respective loading racks are of equal height, and the power conversion modules 5 accommodated in the two loading layers 2201 are arranged face-to-face. With the above structural form, the arrangement of the power conversion modules 5 is more orderly, which facilitates the maintenance and wiring operations.

In some other specific implementations, the above second loading platform 2 may further include a first loading zone 21 equipped with a switch control module 4. The first loading zone 21 and the second loading zone 22 are arranged sequentially in the Z direction (that is, the first loading zone 21 and the second loading zone 22 are arranged from bottom to top in the Z direction). The switch control module 4 is electrically connected to the voltage boosting and power distribution control device 3 through a busbar assembly, and the power conversion modules 5 are electrically connected to the switch control module 4 through a connecting cable 6. Since the switch control module 4 is located in the first loading zone 21 and the power conversion modules 5 are located in the second loading zone 22, the electrical connection between the switch control module 4 and the power conversion modules 5 is more convenient.

It should be noted that the switch control module 4 may specifically be in a structure form of a switch cabinet, including components such as fuses and isolating switches. Specifically, a protective panel and a protective door are provided outside the switch control module 4 with the protective door being openable and closable for maintenance. In addition, the switch control module 4 on the second loading platform 2 may specifically be a fuse-equipped switch cabinet, containing a fuse and an isolating switch which are configured to control each circuit, and input wiring may also be implemented inside the cabinet (if the fuses are not needed, a wiring bar can be simply used). The AC circuits are bused together and connected to a low-voltage side of the medium-voltage transformer 31 through a copper bar, and after the voltage is boosted, the power is directly output for grid connection or output through a ring main unit for grid connection. The distribution cabinet 32, the communication cabinet 33, and the like are all integrated within the integrated architecture, allowing the current to be inputted from one side of the integrated architecture and directly output at the other side for grid connection for the user, with the intermediate control and conversion processes all realized within the integrated architecture, greatly facilitating on-site construction for the user and also saving a large amount of connecting cables between different devices, and thereby reducing costs for the user. According to actual power requirements, a single integrated architecture or two connected integrated architectures may be employed.

In further implementations, referring to FIGS. 1 to 4, the switch control module 4 may include multiple integrated switch control units 40, with each integrated switch control unit 40 integrating a DC switch assembly 401 and an AC switch assembly 402. The power conversion modules 5 accommodated on the loading rack 220 are arranged in columns each extending in the Z direction, with each integrated switch control unit 40 correspondingly controlling one column of power conversion modules 5, and the integrated switch control unit 40 being located below the one column of power conversion modules 5. Specifically, the DC and AC fuses and switches for each column of power conversion modules 5 are correspondingly placed below the column to reduce the connecting cable paths. The entire current path is as follows. The DC switch assembly 401 is connected to the input of the power conversion module 5 through the connecting cable 6, then the output of the power conversion module 5 is connected to the AC switch assembly 402 through the connecting cable, and finally the alternating currents from all the circuits are converged into the AC busbar. This arrangement allows the power conversion modules 5 in the same column to be connected to the corresponding integrated switch control unit 40 nearby, and since the integrated switch control unit 40 integrates both DC switch assembly 401 and AC switch assembly 402, the connections are more convenient.

In further implementations, the integrated switch control units 40 are arranged in a row in the X direction below each corresponding loading rack 220. This structural design makes the arrangement of the switch control module 4 neater.

In some other specific implementations, the switch control module 4 may include an integrated DC switch module 41 and an integrated AC switch module 42. The integrated DC switch module 41 is used for integrated control of DC sides of the power conversion modules 5, while the integrated AC switch module 42 is used for integrated control of AC sides of the power conversion modules 5. The switch control module 4 is designed to include the integrated DC switch module 41 and the integrated AC switch module 42 being independent of each other, the placement of these modules becomes more flexible.

For example, referring to FIGS. 11 to 13, the second loading zone 22 includes two loading racks 220 arranged face-to-face in the Y direction, with the integrated DC switch module 41 positioned below one of the loading racks 220 and the integrated AC switch module 42 positioned below the other loading rack 220, and a maintenance passage is formed between the integrated DC switch module 41 and the integrated AC switch module 42, where the Y direction represents the width direction of the integrated architecture. This structural design makes the integrated DC switch module 41 and the integrated AC switch module 42 relatively independent, facilitating easier maintenance and wiring, thereby reducing the risk of wiring errors.

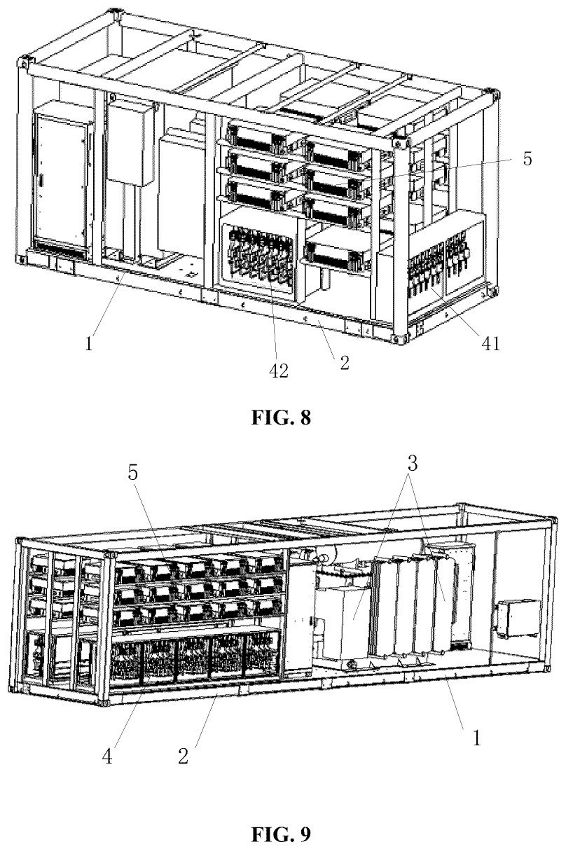

For another example, as shown in FIG. 8, one of the integrated DC switch module 41 and the integrated AC switch module 42 is placed below the loading rack 220 (being placed below the multiple loading racks 220 when multiple loading racks 220 are provided, for instance, below the two loading racks 220 symmetrically arranged), and the other is arranged at a side of the first loading zone 21 away from the first loading platform 1. This arrangement maximizes the space utilization of the first loading zone 21.

It should be noted that the switch control module 4, which includes fuses and switches within the switch cabinet, may be configured in multiple combinations based on the number and placement of the power conversion modules 5. For example, the integrated DC switch module and the integrated AC switch module are arranged in the same cabinet and on two sides of the second loading platform respectively; or, the integrated DC switch module and the integrated AC switch module are arranged in the same cabinet and on the same side of the second loading platform; or, the integrated DC switch module and the integrated AC switch module are arranged in single cabinets respectively and are used together. Each of the above forms is configured to ensure that all operations and maintenance face the user's side, which facilitates using.

In some other specific implementations, the power conversion module 5 may integrate a DC switch module, and the switch control module 4 is configured with multiple AC switch modules. Alternatively, the power conversion module 5 may integrate an AC switch module, and the switch control module 4 is configured with multiple DC switch modules. This design allows the switch control module 4 to be equipped with only one type of switch module between the AC switch module and DC switch module, which is beneficial to reducing the space occupied by the switch control module 4, and thereby increasing the arrangement space in the second loading zone 22.

In some specific implementations, referring to FIGS. 1 to 13, for each of the at least one loading rack, wiring interfaces of the power conversion modules 5 located on the loading rack all face an outer side of loading rack 220 in the Y direction. The Y direction represents the width direction of the integrated architecture. The above arrangement facilitates easier maintenance and wiring of the power conversion modules 5.

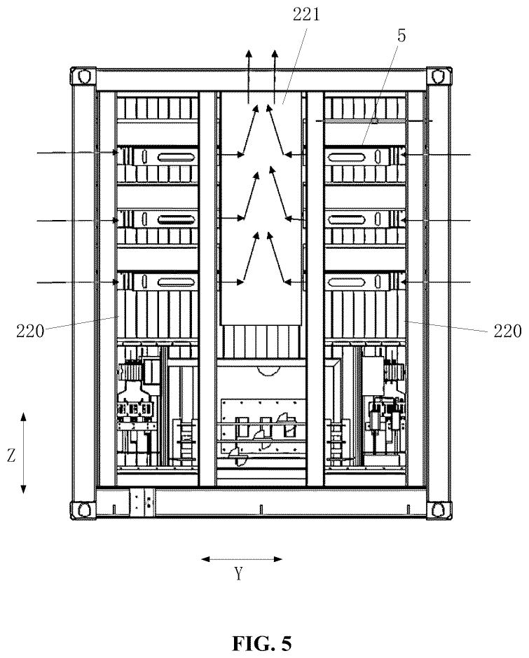

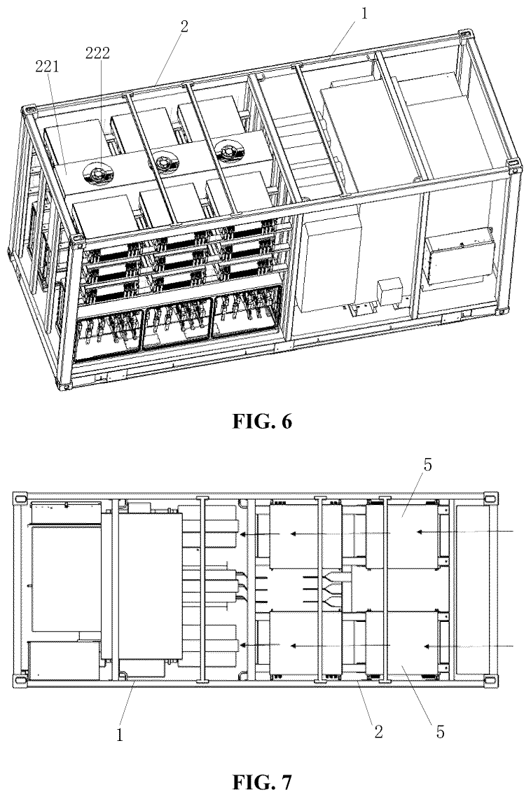

In some other specific implementations, the power conversion module 5 may have an air inlet and an air outlet both arranged along the X direction, as shown in FIG. 7. Alternatively, the air inlet and the air outlet may be both arranged along the Y direction, as shown in FIGS. 5 and 6, where the Y direction represents the width direction of the integrated architecture. Alternatively, the air inlet and the air outlet are arranged in a manner that one is along the X and the other is along the Y direction. In practical applications, the arrangement can be selected based on actual needs, which will not be specifically limited herein.

In a further implementation, when the air inlet and the air outlet of the power conversion module 5 are arranged along the Y direction, the second loading zone 22 includes two loading racks 220 arranged face-to-face in the Y direction, with the power conversion modules 5 accommodated on the two racks are configured in either a face-to-face air intake arrangement or a back-to-back air intake arrangement, where the Y direction represents the width direction of the integrated architecture. This structural design facilitates the arrangement of the cooling air ducts for the power conversion modules 5.

In a further implementation, as shown in FIGS. 5 and 6, a cooling air duct 221 and a fan 222 mounted in the cooling air duct 221 are provided between the two loading racks 220. The cooling air duct 221 includes an air duct inlet and an air duct outlet. When the power conversion modules 5 accommodated on the two loading racks 220 are configured in a face-to-face air intake arrangement, the air duct inlets are in communication with the air outlets of the power conversion modules 5 in one-to-one correspondence, and the fan 222 is an exhaust fan mounted at the air duct outlet. When the power conversion modules 5 accommodated on the two loading racks 220 are configured in the back-to-back air intake arrangement, the air duct outlets are in communication with the air inlets of the power conversion modules 5 in one-to-one correspondence, and the fan 222 is a blower fan mounted at the air duct inlet. The design of the cooling air duct 221 and the fan 222 ensures more uniform cooling of the power conversion modules 5 accommodated on the two loading racks 220.

It should be noted that the fan 222 may be mounted at the top of the cooling air duct 221, or at the bottom of the cooling air duct 221, or both the top and bottom of the cooling air duct 221. In practical applications, the specific configuration can be made based on actual needs.

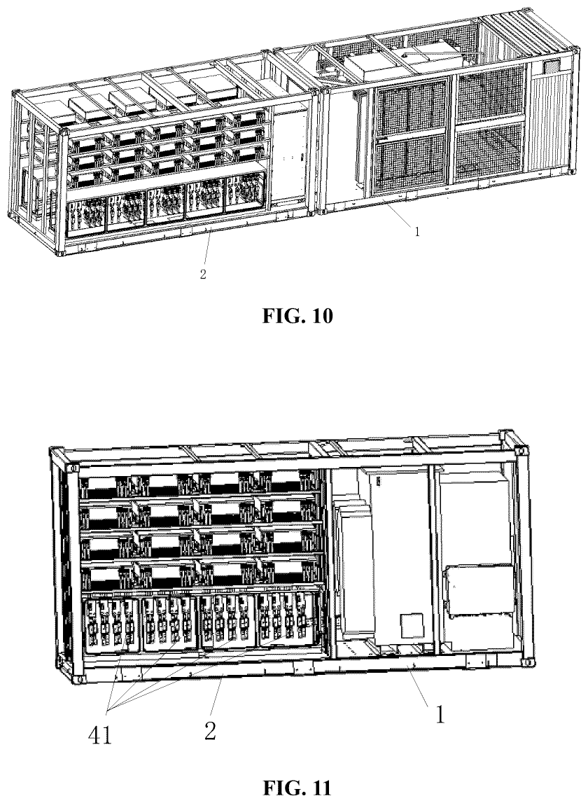

In some specific implementations, the first loading platform 1 and the second loading platform 2 may be formed as an integral loading platform, as shown in FIG. 9. Alternatively, they may be designed as separate loading platforms coupled together, as shown in FIG. 10.

It should be noted that all the embodiments in this specification are described in a progressive way, and each embodiment focuses on the differences from other embodiments. The same and similar parts among the embodiments can be referred to each other.

It should be understood that if terms “system”, “device”, “unit” and/or “module” are used herein, it is merely a way for distinguishing different members, elements, components, portions or assemblies at different levels. However, if other expressions can realize the same purpose, they may be used to replace the above terms.

As shown in the specification and claims of this application, unless the context clearly indicates an exception, the words such as “one”, “a”, “an” and/or “the” do not specifically refer to the singular, but may also include the plural. Generally speaking, the terms “include” and “comprise” only indicate the inclusion of clearly identified steps and elements, and these steps and elements do not constitute an exclusive list, and a method or device may also include other steps or elements. The elements limited by the statement “comprising (including) a . . . ” do not exclude the existence of other identical elements exist in the process, method, product or apparatus that includes the elements.

In the description of the embodiments of the present application, unless otherwise specified, “/” means or, for example, A/B means A or B. The “and/or” herein is only an association relationship that describes the associated objects, which means that there may be three kinds of relationships, for example, A and/or B may mean that there are three cases: A alone, A and B at the same time, and B alone. In addition, in the description of the embodiments of the present application, “multiple” refers to two or more.

Hereinafter, the terms “first” and “second” are only used for descriptive purposes, and cannot be understood as indicating or implying relative importance or implicitly indicating the number of indicated technical features. Therefore, a feature defined by “first” or “second” may explicitly or implicitly include one or more of the features.

If a flowchart is used in the present application, the flowchart is used to explain the operation performed by the system according to the embodiment of the present application. It should be understood that the preceding or subsequent operations are not necessarily performed accurately in sequence. Instead, the steps can be processed in reverse order or simultaneously. In addition, other operations can be added to these procedures, or one or more operations can be removed from these procedures.

The principle and implementations of the present application are described herein by using specific examples, and the description of the above embodiments is only used to help understand the core idea of the present application. It should be noted that, several improvements and modifications may be made by those skilled in the art to the present application without departing from the principle of the present application, and these improvements and modifications also fall within the protection scope of the claims of the present application.

1. A integrated architecture of a power conversion system, comprising a first loading platform and a second loading platform arranged sequentially along an X direction, wherein
the first loading platform is equipped with a voltage boosting and power distribution control device;
the second loading platform comprises a second loading zone, wherein the second loading zone is provided with at least one loading rack arranged sequentially along at least one of the X direction and a Y direction, each of the at least one loading rack comprises a plurality of loading layers arranged sequentially in a Z direction, and the plurality of loading layers are configured to accommodate power conversion modules; and wherein
the X direction is a length direction of the integrated architecture, the Y direction is a width direction of the integrated architecture, and the Z direction is a height direction of the integrated architecture.

2. The integrated architecture of the power conversion system according to claim 1, wherein the numbers of power conversion modules accommodated on two of the plurality of loading layers of a same one of the at least one loading rack are the same or different.

3. The integrated architecture of the power conversion system according to claim 1, wherein when the second loading zone comprises a plurality of loading racks, the number of loading layers is the same or different among the plurality of loading racks.

4. The integrated architecture of the power conversion system according to claim 3, wherein when the number of loading layers is the same among the plurality of loading racks, two of the plurality of loading layers sharing the same ordinal position are of equal height, with the power conversion modules accommodated on the two of the plurality of loading layers arranged face-to-face.

5. The integrated architecture of the power conversion system according to claim 1, wherein the second loading platform further comprises a first loading zone equipped with a switch control module, and the first loading zone and the second loading zone are arranged sequentially in the Z direction; and wherein
the switch control module is electrically connected to the voltage boosting and power distribution control device through a busbar assembly; and
the power conversion modules are electrically connected to the switch control module through connecting cables.

6. The integrated architecture of the power conversion system according to claim 5, wherein the switch control module comprises a plurality of integrated switch control units, each of which integrates a DC switch assembly and an AC switch assembly; and
the power conversion modules accommodated on the at least one loading rack are arranged in columns along the Z direction, with each of the plurality of integrated switch control units configured to control a corresponding one of the columns of power conversion modules, and the integrated switch control unit being located below the corresponding one of the columns of power conversion modules.

7. The integrated architecture of the power conversion system according to claim 6, wherein ones of the plurality of integrated switch control units are arranged in a row along the X direction below the corresponding one of the at least one loading rack.

8. The integrated architecture of the power conversion system according to claim 5, wherein the switch control module comprises an integrated DC switch module and an integrated AC switch module.

9. The integrated architecture of the power conversion system according to claim 8, wherein the second loading zone comprises two loading racks arranged face-to-face in the Y direction, the integrated DC switch module is arranged below one of the two loading racks, the integrated AC switch module is arranged below the other of the two loading racks, and a maintenance passage is provided between the integrated DC switch module and the integrated AC switch module.

10. The integrated architecture of the power conversion system according to claim 8, wherein one of the integrated DC switch module and the integrated AC switch module is arranged below the at least one loading rack, and the other is arranged on a side of the first loading zone facing away from the first loading platform.

11. The integrated architecture of the power conversion system according to claim 5, wherein each of the power conversion modules is integrated with a DC switch module, and the switch control module is configured as a plurality of AC switch modules; or
each of the power conversion modules is integrated with an AC switch module, and the switch control module is configured as a plurality of DC switch modules.

12. The integrated architecture of the power conversion system according to claim 1, wherein for each of the at least one loading rack, wiring interfaces of the power conversion modules located on the loading rack all face an outer side of the loading rack in the Y direction.

13. The integrated architecture of the power conversion system according to claim 1, wherein each of the power conversion modules has an air inlet and an air outlet arranged along the X direction, and/or
each of the power conversion modules has an air inlet and an air outlet arranged along the Y direction.

14. The integrated architecture of the power conversion system according to claim 13, wherein when each of the power conversion modules has the air inlet and the air outlet arranged along the Y direction, the number of the at least one loading rack is plural, wherein two of the plurality of loading racks are arranged face-to-face in the Y direction in the second loading zone, and the power conversion modules accommodated on the two loading racks are configured in either a face-to-face air intake arrangement or a back-to-back air intake arrangement.

15. The integrated architecture of the power conversion system according to claim 14, wherein a cooling air duct is provided between the two loading racks, a fan is mounted in the cooling air duct, and the cooling air duct comprises an air duct inlet and an air duct outlet; wherein
when the power conversion modules accommodated on the two loading racks are configured in the face-to-face air intake arrangement, the number of the air duct inlet is plural, the air duct inlets are in communication with the air outlets of the power conversion modules in one-to-one correspondence, and the fan is an exhaust fan mounted at the air duct outlet; and
when the power conversion modules accommodated on the two loading racks are configured in the back-to-back air intake arrangement, the number of the air duct outlet is plural, the air duct outlets are in communication with the air inlets of the power conversion modules in one-to-one correspondence, and the fan is a blower fan mounted at the air duct inlet.

16. The integrated architecture of the power conversion system according to claim 15, wherein the fan is mounted at a top and/or a bottom of the cooling air duct.

17. The integrated architecture of the power conversion system according to claim 1, wherein the first loading platform and the second loading platform are formed as an integral loading platform or separate loading platforms coupled together.

18. The integrated architecture of the power conversion system according to claim 1, wherein the power conversion module is an energy storage converter or a photovoltaic inverter.
